(19) United States
(12) Patent Application Publication
(10) Pub. No.: US 2008/0099281 A1
(43) Pub. Date: May 1, 2008

(54) SPRING MOTOR AND DRAG BRAKE FOR DRIVE FOR COVERINGS FOR ARCHITECTURAL OPENINGS

(75) Inventors: Richard Anderson, Whitesville, KY (US); Donald E. Fraser, Owensboro, KY (US); Robert E. Fisher, Owensboro, KY (US)

Correspondence Address: CAMORIANO & ASSOCIATES, 8225 SHELBYVILLE ROAD, LOUISVILLE, KY, 40222, US

(73) Assignee: Hunter Douglas Inc., Upper Saddle River, NJ (US)

(21) Appl. No.: 11/876,360

(22) Filed: Oct. 22, 2007

Related U.S. Application Data
(60) Provisional application No. 60/862,855, filed on Oct. 25, 2006.
(60) Provisional application No. 60/909,077, filed on Mar. 30, 2007.

(51) Int. Cl. E06B 9/322

(52) U.S. Cl. 185/37

(57) ABSTRACT

A spring motor and drag brake for use in coverings for architectural openings.

This application claims priority from U.S. Provisional Application Ser. No. 60/862,855 filed Oct. 25, 2006, and from U.S. Provisional Application Ser. No. 60/909,077 filed Mar. 30, 2007, which are hereby incorporated herein by reference.

### BACKGROUND

The present invention relates to a spring motor and drag brake which can be used for opening and closing or tilting coverings for architectural openings such as Venetian blinds, pleated shades, vertical blinds, other expandable materials, and other mechanical devices.

Typically, a blind transport system will have a head rail which both supports the covering and hides the mechanisms used to raise and lower or open and close the covering. Such a blind system is described in U.S. Pat. No. 6,536,503, Modular Transport System for Coverings for Architectural Openings, which is hereby incorporated herein by reference. In the typical top/down product, the raising and lowering of the covering is done by a lift cord or lift cords suspended from the head rail and attached to the bottom rail (also referred to as the moving rail or bottom slat). The opening and closing of the covering is typically accomplished with ladder tapes (and/or tilt cables) which run along the front and back of the stack of slats. The lift cords usually run along the front and back of the stack of slats or through holes in the slats. In these types of coverings, the force required to raise the covering is at a minimum when it is fully lowered (fully extended), since the weight of the slats is supported by the ladder tape so that only the bottom rail is being raised at the onset. As the covering is raised further, the slats stack up onto the bottom rail, transferring the weight of the slats from the ladder tape to the lift cords, so progressively greater lifting force is required to raise the covering as it approaches the fully raised (fully retracted) position.

Some window covering products are built in the reverse (bottom up), where the moving rail, instead of being at the bottom of the window covering bundle, is at the top of the window covering bundle, between the bundle and the head rail, such that the bundle is normally accumulated at the bottom of the window when the covering is retracted and the moving rail is at the top of the window covering, next to the head rail, when the covering is extended. There are also composite products which are able to do both, to go top down and/or bottom up.

In horizontal window covering products, there is an external force of gravity against which the operator is acting to move the expandable material from one of its expanded and retracted positions to the other.

In contrast to a blind, in a top down shade, such as a shear horizontal window shade, the entire light blocking material typically wraps around a rotator rail as the shade is raised. Therefore, the weight of the shade is transferred to the rotator rail as the shade is raised, and the force required to raise the shade is thus progressively lower as the shade (the light blocking element) approaches the fully raised (fully open) position. Of course, there are also bottom up shades and composite shades which are able to do both, to go top down and/or bottom up. In the case of a bottom/up shade, the weight of the shade is transferred to the rotator rail as the shade is lowered, mimicking the weight operating pattern of a top/down blind.

In the case of vertically-oriented window coverings, which move from side to side rather than up and down, a first cord is usually used to pull the covering to the retracted position and then a second cord (or second end of the first cord) is used to pull the covering to the extended position. In this case, the operator is not acting against gravity. However, these window coverings may also be arranged to have another outside force or load other than gravity, such as a spring, against which the operator would act to move the expandable material from one position to another.

A wide variety of drive mechanisms is known for extending and retracting coverings—moving the coverings vertically or horizontally or tilting slats. A number of these drive mechanisms may use a spring motor to provide the catalyst force (and/or to supplement the operator supplied catalyst force) to move the coverings.

### BRIEF DESCRIPTION OF THE DRAWINGS

FIG. 1 is a partially exploded perspective view of a window shade and the drive for this window shade incorporating a spring motor;

FIG. 2 is an exploded perspective view of the spring motor of FIG. 1;

FIG. 3 is a perspective view of the assembled motor of FIG. 2;

FIG. 4 is an end view of the spring motor of FIG. 3;

FIG. 5 is a sectional view along line 5-5 of FIG. 4;

FIG. 6A is a perspective view of a top down/bottom up shade incorporating the spring motors of FIG. 3;

FIG. 6B is a partially exploded perspective view of the head rail of FIG. 6A, incorporating two sets of drives in the head rail;

FIG. 7 is an exploded perspective view of another embodiment of a spring motor;

FIG. 8 is a perspective view of the assembled motor of FIG. 7;

FIG. 9 is an end view of the spring motor of FIG. 8;

FIG. 10 is a sectional view along line 10-10 of FIG. 9;

FIG. 11 is a perspective view of the assembled motor output shaft, coil springs, and spring coupler of FIG. 7;

FIG. 12 is an exploded, perspective view of another embodiment of a spring motor;

FIG. 12A is an exploded, perspective view similar to that of FIG. 12 of another embodiment of a spring motor;

FIG. 13 is an assembled view of the spring motor of FIG. 12;

FIG. 14 is an end view of the spring motor of FIG. 13;

FIG. 15A is a sectional view along line 15-15 of FIG. 14;

FIG. 15B is a perspective view of the assembled drag brake drum, riding sleeves, and coil springs of FIG. 12;

FIG. 16 is an exploded, perspective view of another embodiment of a spring motor;

FIG. 17 is an assembled view of the spring motor of FIG. 16;

FIG. 18 is a sectional view similar to that of FIG. 15, but for the spring motor of FIG. 17;

FIG. 19 is a schematic of the three steps involved in the reverse winding of a flat spring motor; and

FIG. 20 is graph showing the torque curves of a standard-wound spring and a reverse-wound spring.

### DESCRIPTION

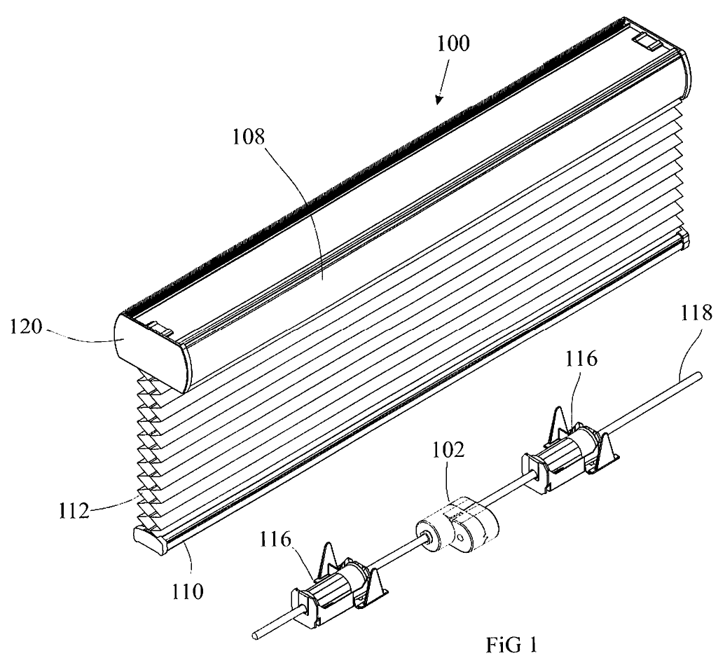

FIGS. 1 through 20 illustrate various embodiments of spring motors. These spring motors can be used for extending and retracting window coverings by raising and lowering them, moving them from side to side, or tilting their slats open and closed. Window coverings or coverings for architectural openings may also be referred to herein more specifically as blinds or shades.

FIG. 1 is a partially exploded, perspective view of a first embodiment of a cellular shade 100 utilizing a spring motor and drag brake combination 102.

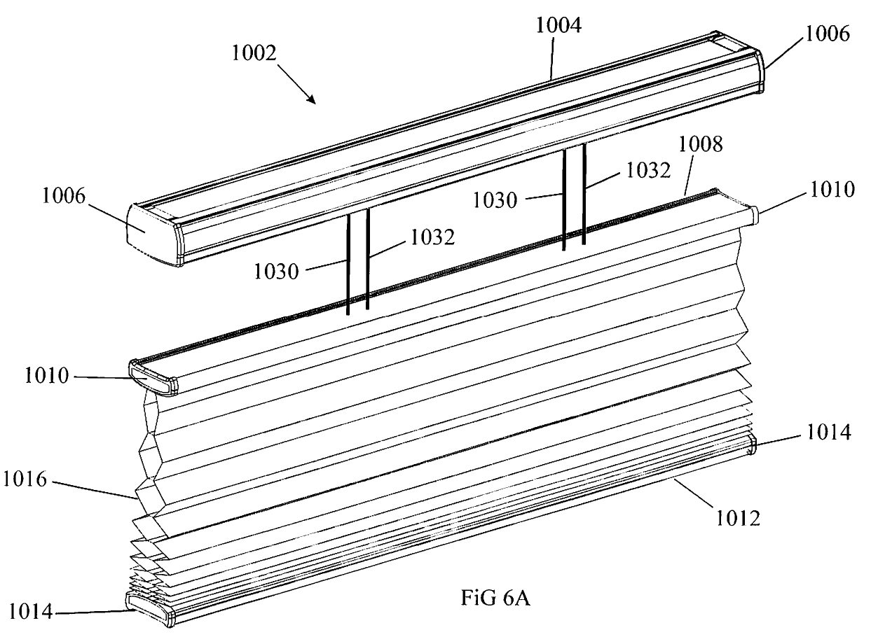

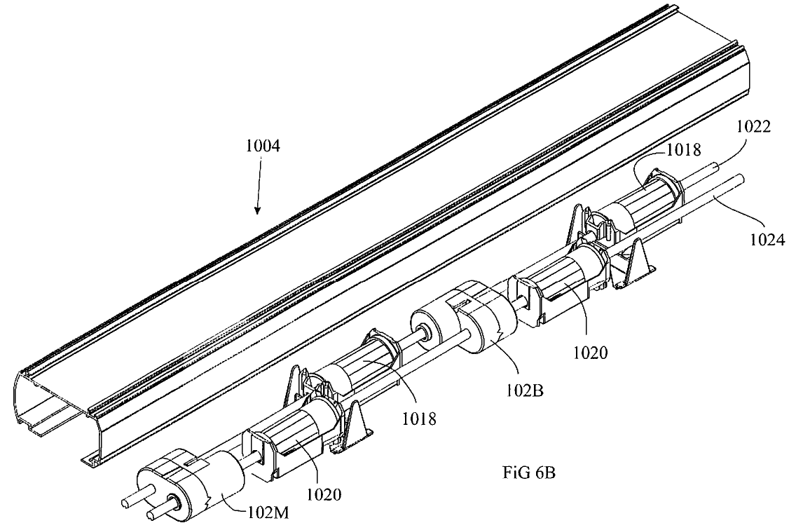

The shade 100 of FIG. 1 includes a head rail 108, a bottom rail 110, and a cellular shade structure 112 suspended from the head rail 108 and attached to both the head rail 108 and the bottom rail 110. The covering material 112 has a width that is essentially the same as the length of the head rail 108 and of the lift rod 118, and it has a height when fully extended that is essentially the same as the length of the lift cords (not shown in this view but two sets are shown in FIG. 6A), which are attached to the bottom rail 110 and to lift stations 116 such that when the lift rod 118 rotates, the lift spools on the lift stations 116 also rotate, and the lift cords wrap onto or unwrap from the lift stations 116 to raise or lower the bottom rail 110 and thus raise or lower the shade 100. These lift stations 116 and their operating principles are disclosed in U.S. Pat. No. 6,536,503 “Modular Transport System for Coverings for Architectural Openings”, issued Mar. 25, 2003, which is hereby incorporated herein by reference. End caps 120 close the ends of the head rail 108 and may be used to mount the cellular product 100 to the architectural opening.

Disposed between the two lift stations 116 is a spring motor and drag brake combination 102 which is functionally interconnected to the lift stations 116 via the lift rod 118 such that, when the spring motor rotates, the lift rod 118 and the spools on the lift stations 116 also rotate, and vice versa, as discussed in more detail below. The use of spring motors to raise and lower window blinds was also disclosed in the aforementioned U.S. Pat. No. 6,536,503 “Modular Transport System for Coverings for Architectural Openings”.

In order to raise the shade, the user lifts up on the bottom rail 110. The spring motor assists the user in raising the shade. At the same time, the drag brake portion of the spring motor and drag brake combination 102 exerts a resistance to this upward motion of the shade. As explained below, the drag brake exerts two different torques to resist rotation, depending upon the direction of rotation. In this embodiment, the resistance to the upward motion that is exerted by the drag brake is the lesser of the two torques (referred to as the release torque), as explained in more detail below. This release torque, together with system friction and the torque due to the weight of the shade, is large enough to prevent the spring motor from causing the shade 100 to creep up once the shade has been released by the user.

To lower the shade, the user pulls down on the bottom rail 110, with the force of gravity assisting the user in this task. While pulling down on the bottom rail 100, the spring motor is rotated so as to increase the potential energy of the flat spring (by winding the flat spring of the motor onto its output spool 122, as explained in more detail below). The drag brake portion of the combination 102 exerts a resistance to this downward motion of the shade, and this resistance is the larger of the two torques (referred to as the holding torque) exerted by the drag brake, as explained in more detail below. This holding torque, combined with the torque exerted by the spring motor and system friction, is large enough to prevent the shade 100 from falling down. Thus, the shade remains in the position where it is released by the operator regardless of where the shade is released along its full range of travel; it neither creeps upwardly nor falls downwardly when released.

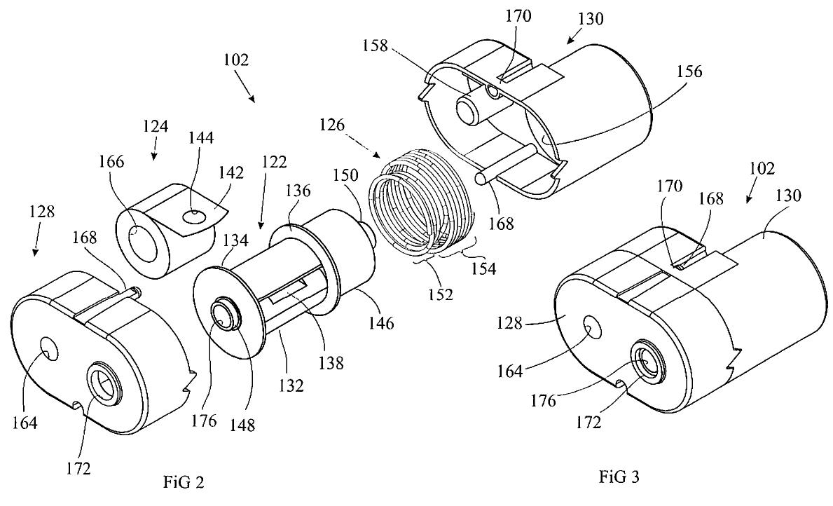

Referring now to FIG. 2, the spring motor and drag brake combination 102 includes a motor output spool 122, a flat spring 124 (also referred to as a motor spring 124), a stepped coil spring 126, a motor housing portion 128, and a brake housing portion 130. The two housing portions 128, 130 connect together to form a complete housing. It should be noted that, in this embodiment, the brake housing portion 130 extends beyond the brake mechanism to enclose part of the motor as well.

The motor output spool 122 (See also FIG. 5) includes a spring take-up portion 132, which is flanked by beveled left and right shoulders 134, 136, respectively, and defines an axially oriented flat recess 138 including a raised button 140 (See FIG. 5) for securing a first end 142 of the flat spring 124 to the motor output spool 122. The first end 142 of the flat spring 124 is threaded into the flat recess 138 of the spring take-up portion 132 until the raised button 140 of the spring take-up portion 132 snaps through the opening 144 at the first end 142 of the flat spring 124, releasably securing the flat spring 124 to the motor output spool 122.

The motor output spool 122 further includes a drag brake drum portion 146 extending axially to the right of the right shoulder 136. Stub shafts 148, 150 extend axially from each end of the motor output spool 122 for rotational support of the motor output spool 122 as described later.

The flat spring 124 is a flat strip of metal which has been wound tightly upon itself as depicted in FIG. 2. As discussed above, a first end 142 of the spring 124 defines a through opening 144 for releasably securing the flat spring 124 to the motor output spool 122. The routing of the flat spring 124, as seen from the vantage point of FIG. 2, is for the end 142 of the flat spring 124 to go under the motor output spool 122 and into the flat 138 until the button 140 snaps into the through opening 144 of the flat spring 124.

Referring now to the coil spring 126, it resembles a traditional coil spring except that it defines two different coil diameters. (It should be noted that the coil diameter is just one characteristic of the coil. Another characteristic is its wire diameter or wire cross-sectional dimension.) The first coil portion 152 has a smaller coil diameter and defines an inner diameter which is just slightly smaller than the outside diameter of the drag brake drum 146. The second coil portion 154 has a larger coil diameter and defines an outer diameter which is just slightly larger than the inside diameter of the corresponding cavity 156 (also referred to as the housing bore 156 or drag brake bore 156) defined by the brake housing 130, as described in more detail below.

The brake housing portion 130 defines a cylindrical cavity 156 (which, as indicated earlier is also referred to as the drag brake housing bore 156) which is just slightly smaller in diameter than the outer diameter of the second coil portion 154 of the stepped coil spring 126. The brake housing portion 130 includes an internal hollow shaft projection 158, which, together with a similar and matching internal hollow shaft projection 160 (See FIG. 5) in the motor housing portion 128 defines a flat spring storage spool 162 which defines a through opening 164 extending through the housing portions 128, 130. As explained later, this through opening 164 may be used as a pass-through location for a rod (such as a lift rod or a tilt rod), allowing the placement of two independent drives in very close parallel proximity to each other, resulting in the possibility of using a narrower head rail 108 than might otherwise be possible.

In FIG. 5, the first coil portion 152 of the stepped coil spring 126 is shown as being practically embedded in the drag brake drum portion 146, and the second coil portion 154 is similarly shown as being practically embedded in the drag brake bore 156. In fact, these coil portions 152, 154 are not actually embedded into their respective parts 146, 156, but are shown in this manner to represent the fact that there is an interference fit between the coil portions 152, 154 and their respective drum 146 and housing bore 156. It is the amount of this interference fit as well as the wire diameter or the wire cross-sectional dimension of the stepped coil spring 126 which dictates the release torque and the holding torque which must be overcome in order to cause the brake drum 146 to rotate relative to the housing 130 in a first direction and a second direction, respectively. These two torques may also be referred to as component torques, since they are the torques exerted by or on the drag brake component, as opposed to system torque, which is the torque exhibited by the system as a whole and which may also include torques due to the spring motor portion of the combination 102, friction torques, torque due to the weight of the shade, and so forth.

The coil spring 126 exerts torques against both the brake drum 146 and the bore 156 of the housing 130, and these torques resist rotation of the brake drum 146 relative to the housing 130 in both the clockwise and counterclockwise directions. The amount of torque exerted by the coil spring 126 against the brake drum 146 and the bore 156 varies depending upon the direction of rotation of the brake drum 146 relative to the housing 130, and the place where slippage occurs changes depending upon the direction of rotation. In order to facilitate this description, the coil spring torque that must be overcome in order to rotate the brake drum in one direction relative to the housing will be referred to as the holding torque, and the coil spring torque that must be overcome in order to rotate the brake drum in the other direction relative to the housing will be referred to as the release torque.

The holding torque occurs when the output spool and brake drum rotate in a counterclockwise direction relative to the housing 130 (as seen from the vantage point of FIG. 2) which tends to open up or expand the coil spring 126 away from the drum portion 146 and toward the bore 156 of the housing 130. In this situation, the drag brake drum portion 146 slips past the first coil portion 152 of the coil spring 126, while the second coil portion 154 of the coil spring 126 locks onto the housing bore 156. This holding torque is the higher of the two component torques of this drag brake component, and, in this embodiment, occurs when the flat spring 124 is winding onto the output spool 122 (and unwinding from the storage spool 162, increasing the potential energy of the device 102), which also is when the shade 100 is being pulled down by the user with the assistance of gravitational force.

Thus, when the user pulls down on the bottom rail 110 to overcome the holding torque, the flat spring 124 winds onto the output spool, and the drum 146 slips relative to the coil spring 126. The holding torque is designed to be sufficient to prevent the shade 100 from falling downwardly when the user releases it at any point along the travel distance of the shade 112. (Of course, this arrangement could be reversed, so that the counterclockwise rotation occurs when the user lifts on the bottom rail.)

Similarly, when the bottom rail 110 of the shade 100 is lifted up, the output spool 122 and brake drum 146 rotate in a clockwise direction relative to the bore 156 of the housing 130 (as seen from FIG. 2). The flat spring 124 winds onto the storage spool 162 and unwinds from the output spool 132, aiding the user in the raising of the shade 100. Also, the stepped coil spring 126 rotates in the same clockwise direction, causing the coil spring 126 to contract away from the housing bore 156 and toward the drum 146. This causes the first coil portion 152 to clamp down on the drag brake drum portion 146 and the second coil portion 154 to shrink away from the bore 156. The release torque (the lower of the two torques for this drag brake component) occurs when the stepped coil spring 126 slips relative to the housing bore 156.

Thus, when the operator lifts up on the bottom rail 110, the flat spring 124 winds up onto the storage spool 162 and the coil spring slips relative to the bore 156 as the shade rises.

To summarize, the holding torque is the larger of the two torques for this drag brake component, and it occurs when the coil spring 126 grows or expands such that the second coil portion 154 expands against and “locks” onto the bore 156 of the housing 130, and the first coil portion 152 expands from, and slips relative to, the drag brake drum portion 146. The release torque is the smaller of the two torques for the drag brake component, and it occurs when the drag-brake spring 126 collapses such that the second coil portion 154 contracts away from and slips relative to the bore 156 of the housing 130, and the first coil portion 152 collapses and “locks” onto the drag brake drum portion 146. Both torques for the drag brake component provide a resistance to rotation of the drum 146 and of the output spool 122 relative to the housing 130. The amount of torque for each direction of rotation of the drag brake and which of the torques will be larger depends upon the particular application.

To assemble the spring motor and drag brake combination 102, the flat spring 124 is secured to the output spool 122 as has already been described. The stepped coil spring 126 is slid over the drag brake drum portion 146 of the output spool 122, and this assembly is placed inside the brake housing portion 130 with the central opening 166 of the flat spring 124 sliding over the hollow shaft projection 158 of the brake housing portion 130 and the stepped coil spring 126 disposed inside the drag brake bore 156. The motor housing portion 128 then is mated to the brake housing portion 130. The two housing portions 128, 130 snap together with the pegs 168 and bridges 170 shown (which are fully described in the U.S. patent application Ser. No. 11/382,089 “Snap-Together Design for Component Assembly”, filed on May 8, 2006, which is hereby incorporated herein by reference). The stub shafts 148, 150 of the output spool 122 ride on corresponding through openings 172, 174 (See FIG. 5) in the motor housing portion 128 and the drag brake drum portion 146, respectively, for rotatably supporting the output spool 122.

As seen in FIG. 5, the flat spring 124 is shown in the “fully discharged” position, all wound onto the storage spool 162. The stepped coil spring 126 is shown in an intermediate position wherein the first coil portion 152 is tightly wound around the drag brake drum portion 146, and the second coil portion 154 is also tightly wound against the drag brake bore 156. As explained earlier, as the bottom rail 110 of the shade 100 is pulled downwardly by the user, the stepped coil spring 126 expands or opens up such that the second coil portion 154 locks tightly onto the drag brake bore 156, while the first coil portion 152 expands away from the drag brake drum portion 146, which allows the brake to slip at the brake drum portion 146, at the higher of the two torques for the drag brake component, which is referred to as the holding torque. The user must overcome this holding torque as well as the torque required to wind the flat spring 24 onto the output spool 122 and any other system torques in order to lower the shade 100, and these are also the torques which prevent the shade from falling downwardly once the user releases the shade 100.

FIG. 1 shows how the spring motor and drag brake combination 102 may be installed in a shade 100. Since the lift rod 118 goes completely through the spring motor and drag brake combination 102 (via the axially-aligned through opening 176 in the output spool 122), the spring motor and drag brake combination 102 may be installed anywhere along the length of the head rail 108, either between the lift stations 116 or on either side of the lift stations 116. This design gives much more mounting flexibility than that afforded by prior art designs.

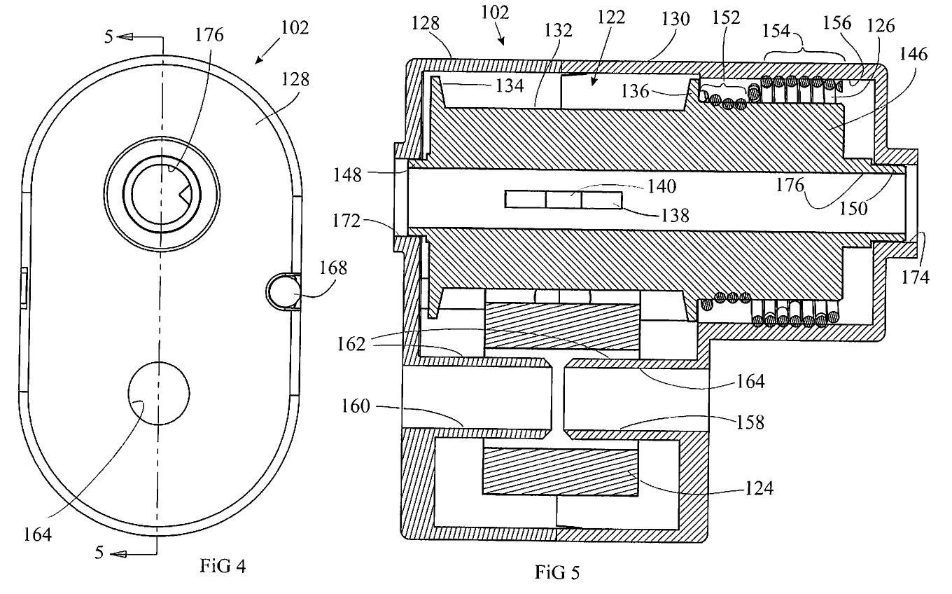

Note in FIG. 4 that this through opening 176 in the output spool 122 has a non-circular profile. In fact, in this particular embodiment, it has a “V” notch profile 176 which matches the similarly profiled lift rod 118. Thus, rotation of the output spool 122 results in corresponding rotation of the lift rod 118 and vice versa.

The storage spool 162 is also a hollow spool, defining a through opening 164 through which another rod, such as another lift rod 118 may extend. However, this opening 164 does not mate with the rod for driving engagement but simply provides a passageway for the rod to pass through. This results in a very compact arrangement for two independent parallel drives as shown in FIG. 6B. This is particularly desirable for the operation of a bottom up/top down shade 1002 as shown in FIG. 6A.

The ability to mount a type of drive-controlling element such as a spring motor or a brake anywhere along a plurality of shafts, as shown in FIG. 6B, permits a wide range of functionality to be achieved. The arrangement shown in FIG. 6B uses one shaft 1022 to raise and lower one part of the covering and another shaft 1024, parallel to the first shaft 1022, to raise and lower another part of the covering, but the use of two or more shafts permits other functions as well. For instance, one shaft could be used to raise and lower the covering and the other could be used to tilt slats on the covering as described in U.S. Pat. No. 6,536,503.

FIGS. 6A and 6B depict a top down/bottom up shade 1002, which uses two spring motor and drag brake combinations 102, one for each lift rod 1022, 1024. The shade 1002 includes a top rail 1004 with end caps 1006, a middle rail 1008 with end caps 1010, a bottom rail 1012 with end caps 1014, a cellular shade structure 1016, spring motor and drag brake combinations 102M, 102B, two bottom rail lift stations 1018, two middle rail lift stations 1020, a bottom rail lift rod 1022, and a middle rail lift rod 1024.

In the case of the top down/bottom up shade 1002 of FIG. 6B, the spring motor and drag brake combinations 102M, 102B, the lift stations 1018, 1020, and the lift rods 1022, 1024, are all housed in the top rail 1004. Both lift rods or shafts 1022, 1024 pass completely through both of the spring motor and drag brake combinations 102M, 102B, but each of the lift rods or shafts 1022, 1024 engages only one of the spring motor and drag brake combinations and passes through the other without engaging it. The front lift rod 1024 operatively interconnects the two lift stations 1020, the spring motor and drag brake combination 102M, and the middle rail 1008 via lift cords 1030 (See FIG. 6A) but just passes through the other spring motor and drag brake combination 102B. The rear lift rod 1022 interconnects the two lift stations 1018, the spring motor and drag brake combination 102B, and the bottom rail 1012 via lift cords 1032 (See FIG. 6A), but just passes through the other spring motor and drag brake combination 102M.

In this instance, the middle rail 1008 may travel all the way up until it is resting just below the top rail 1004, or it may travel all the way down until it is resting just above the bottom rail 1012, or the middle rail 1008 may remain anywhere in between these two extreme positions. The bottom rail 1012 may travel all the way up until it is resting just below the middle rail 1008 (regardless of where the middle rail 1008 is located at the time), or it may travel all the way down until it is extending the full length of the shade 1002, or the bottom rail 1012 may remain anywhere in between these two extreme positions.

Each lift rod 1022, 1024 operates independently of the other, using its respective components in the same manner as described above with respect to a single rod system, with the front rod 1024 operatively connected to the middle rail 1008, and the rear rod 1022 operatively connected to the bottom rail.

Referring briefly to FIG. 6B, the spring motor and drag brake combinations 102B, 102M may be identical or they may differ in that the stepped coil springs 126 may have a different wire diameter (or different wire cross section dimension) in order to customize the holding and release torques for each brake. A larger diameter wire (or larger wire cross section dimension) used in the stepped coil spring 126 results in higher holding and release torques. Whether identical or not, the spring motor and drag brake combination 102B is “flipped over” when installed, relative to the spring motor and drag brake combination 102M. The lift rod 1022 for the bottom rail 1012 goes through the through opening 176 in the output spool 122 (and engages this output spool 122) of the spring motor and drag brake combination 102B. It also passes through the through opening 164 of the storage spool 162 of the spring motor and drag brake combination 102M. Similarly, the lift rod 1024 for the middle rail 1008 goes through the through opening 176 in the output spool 122 (and engages this output spool 122) of the spring motor and drag brake combination 102M. It also passes through the through opening 164 of the storage spool 162 of the other spring motor and drag brake combination 102B.

It should be noted that it is possible to add more spring motors or more spring motor and drag brake combinations, as desired, and that, because these components provide for the shafts or rods 1022, 1024 to pass completely through their housings, they may be located anywhere along the rods 1022, 1024. It should also be noted that this ability to have two or more shafts passing completely through the housing of a spring-operated drive component, with at least one shaft operatively engaging the spring and at least one other shaft not operatively engaging the spring, permits a wide range of combinations of components within a system. The spring-operated drive component may be a spring motor alone, a spring brake alone, a combination spring motor and spring brake as shown here, or other components.

### Other Embodiments of Spring Motor and Drag Brake Combinations

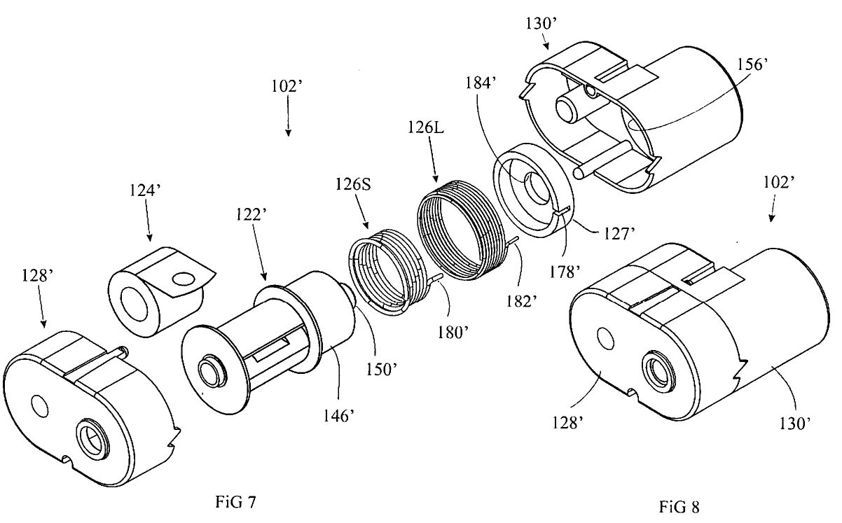

FIGS. 7-11 depict another embodiment of a spring motor and drag brake combination 102′. A comparison with FIG. 2 highlights the differences between this embodiment 102′ and the previously disclosed embodiment 102. This embodiment includes two “conventional” coil springs 126S, 126L functionally linked together by a spring coupler 127′ instead of the single stepped coil spring 126. The first coil spring 126S has a smaller coil diameter, and the second coil spring 126L has a larger coil diameter.

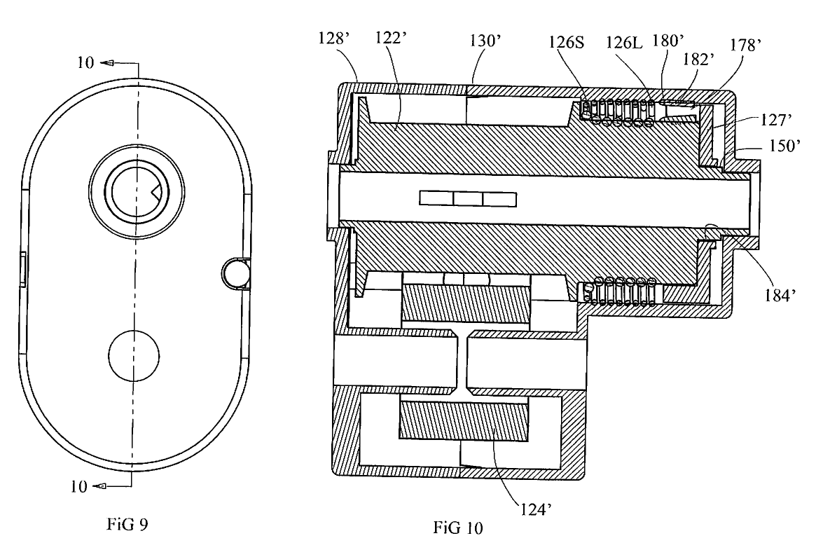

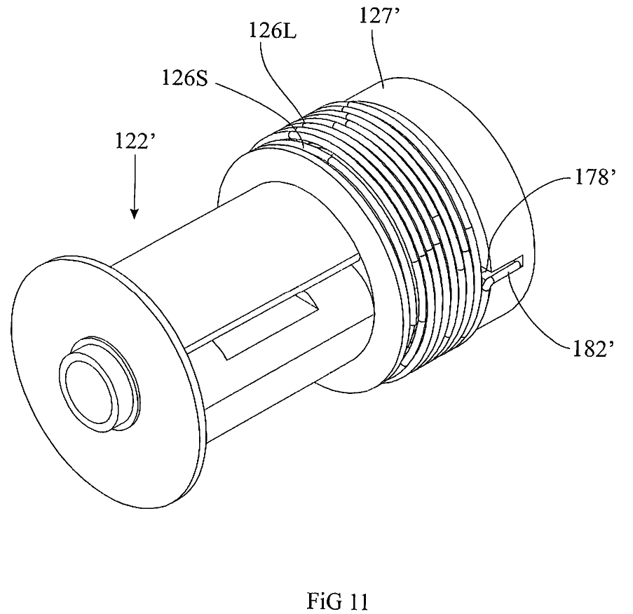

The spring coupler 127′ is a washer-like device which defines a longitudinal slot 178′, which receives the extended ends 180′, 182′ of the coil springs 126S, 126L, respectively. Since the coil spring 126S has a smaller coil diameter, it fits inside the larger diameter coil spring 126L, and the extended ends 180′, 182′ lie adjacent to each other within the slot 178′, as shown in FIG. 10.

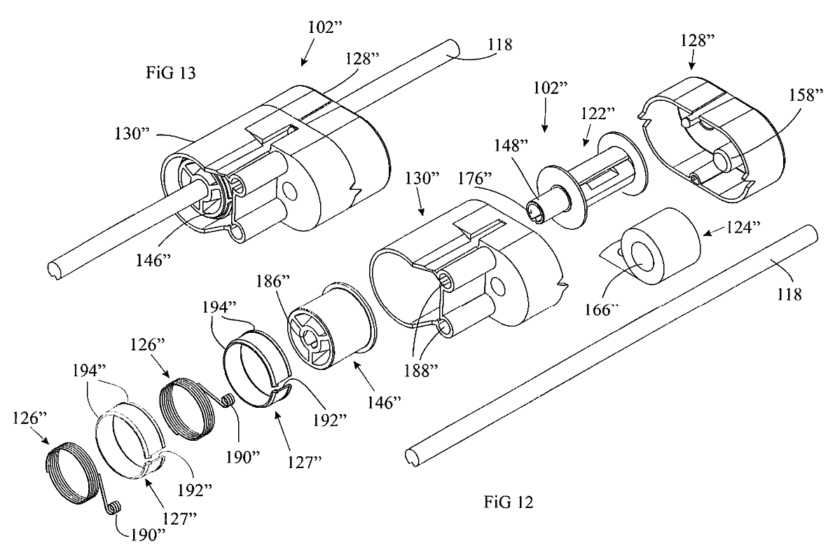

The spring coupler 127′ defines a central opening 184′ which allows the spring coupler 127′ to slide over the stub shaft 150′ of the output spool 122′. The spring coupler 127′ allows for the two springs 126S, 126L to be made of wires having different diameters (or different wire cross-section dimensions, as the wires do not have to be circular in section as these are) and still act as a single spring when the output spool 122′ rotates. FIG. 11 shows the two coil spring 126S, 126L, functionally linked by the spring coupler 127′ and mounted on the output spool 122′.

This spring motor and drag brake combination 102′ behaves in the same manner as the spring motor and drag brake combination 102 described above, except that the use of two coil springs 126S, 126L allows the flexibility to choose the wire cross section dimension for each coil spring 126S, 126L individually. In this manner, the correct (or the desired) brake torques can be chosen more exactly for each application.

For instance, FIG. 7 depicts a larger wire cross section dimension used for the smaller coil spring 126S which clamps around the drag brake drum portion 146′ than the wire cross section dimension used for the larger coil spring 126L which clamps inside the drag brake bore 156′. Since the slip torques (the torques at which the coil spring slips past the surface against which it is clamped) are a function of the diameter of the wire cross section used for the coil springs (the larger the wire cross section dimension the higher the slip torque, everything else being equal), the embodiment shown in FIG. 7 has a larger holding torque (the larger of the two torques) than the holding torque of a similar spring motor and drag brake combination having the smaller spring coil 126S of made from a smaller cross-section wire.

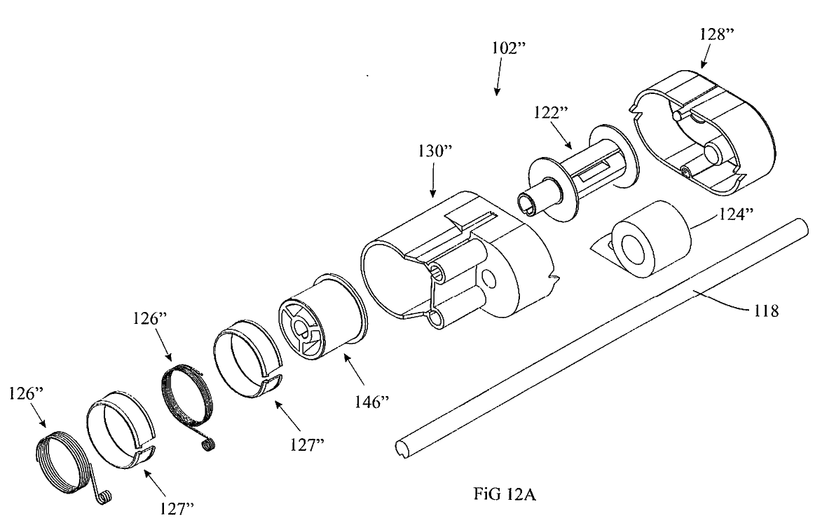

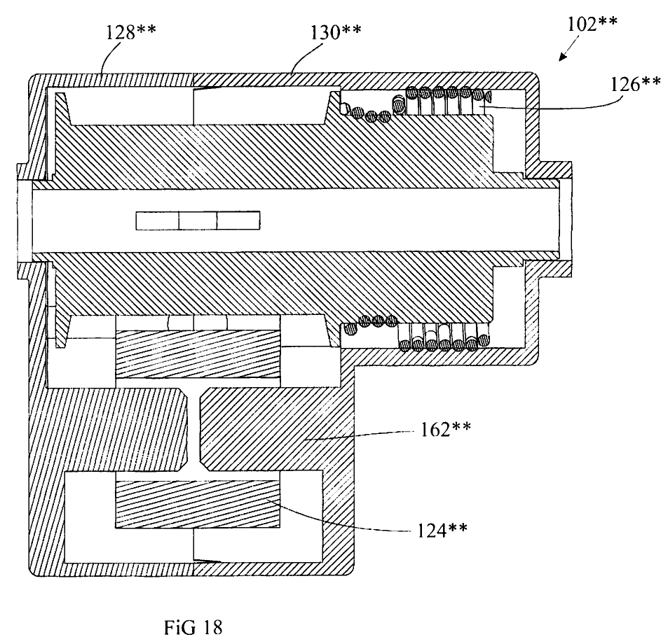

FIGS. 12 and 13-15B depict another embodiment of a spring motor and drag brake combination 102″. A comparison with FIG. 2 quickly highlights the differences between this embodiment 102″ and the previously disclosed embodiment 102. This embodiment 102″ includes a number of identical or very similar components such as a motor output spool 122″, a flat spring 124″ (or motor spring 124″), a motor housing portion 128″, a brake housing portion 130″, a drag brake drum portion 146″, and coil springs 126″. As discussed below, some of these items are slightly different from those described with respect to the previous embodiment, and this embodiment 102″ also has riding sleeves 127″ which are desirable but not strictly necessary for the operation of this spring motor and drag brake combination 102″. (Yet another embodiment 102*, shown in FIG. 16, does not use the sleeves.)

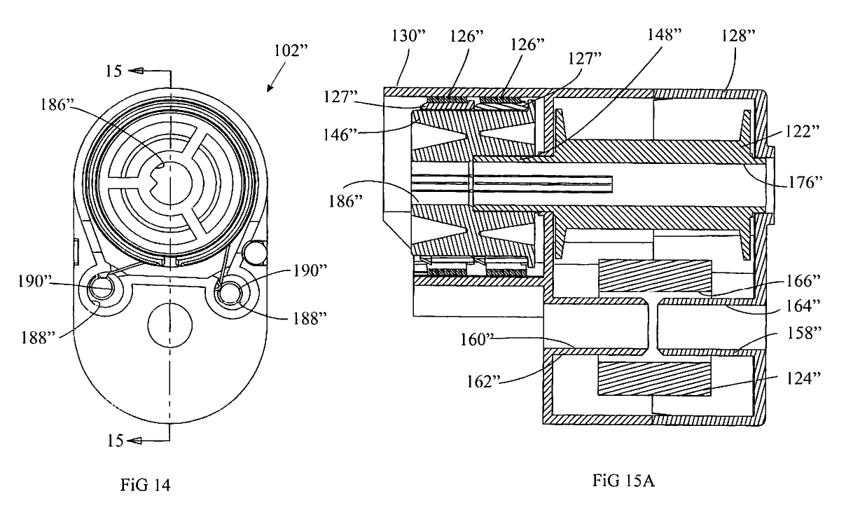

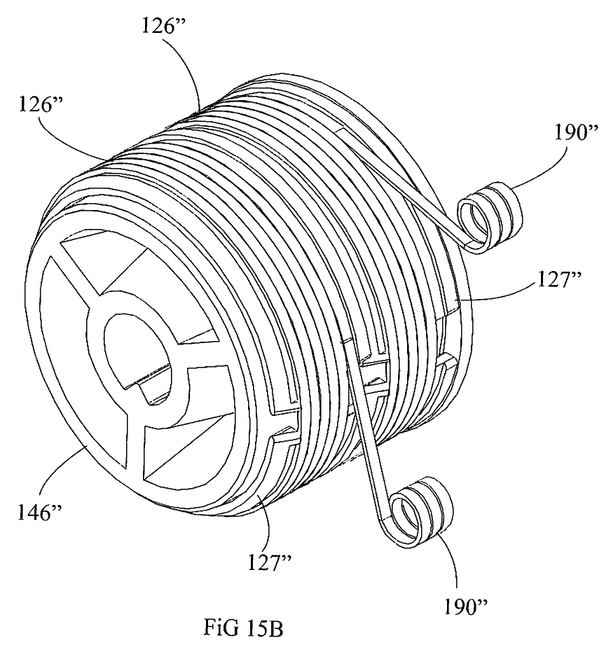

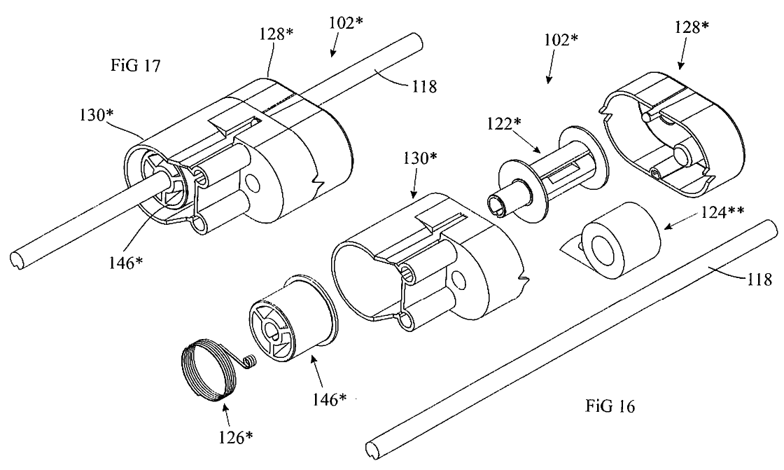

A readily apparent difference is that the drag brake drum portion 146″ is a separate piece which is rotatably supported on the shaft extension 148″ of the motor output spool 122″. As may be appreciated from FIG. 15A, the motor output spool 122″ is rotatably supported on the housing portions 128″, 130″, and the drag brake drum portion 146″ is rotatably supported on the shaft extension 148″ of the motor output spool 122″. The motor output spool 122″ and the drag brake drum portion 146″ have hollow shafts 176″, 186″ with non-circular profiles (See also FIGS. 12 and 14) so as to engage the lift rod 118.

The brake housing portion 130′ includes two “ears” 188″ which define axially-aligned slotted openings to releasably secure the curled ends 190″ of the coil springs 126″ as discussed below.

The riding sleeves 127″ are discontinuous cylindrical rings, with a longitudinal cut 192″, which allows the rings to “collapse” to a smaller diameter. Both riding sleeves 127″ are identical as are both of the coil springs 126″ (though the coil springs 126″ may be of different wire diameters if desired to achieve the desired torque). As will become clearer after the explanation of the operation of this spring motor and drag brake combination 102″, it is possible to use only one set of riding sleeve 127″ and coil spring 126″ if desired and adequate. The embodiment 102″ of FIG. 12 shows two sets of riding sleeves 127″ and coil springs 126″, used to obtain a larger holding torque (more braking power). Certainly, additional sets could also be used if desired (and if able to be accommodated on the drag brake drum portion 146″). Also, the use of the riding sleeves 127″ is optional, as evidenced by the embodiment 102* of FIG. 16 which is described in more detail later.

The coil springs 126″ may ride directly on the outer diameter of the drag brake drum portion 146″, but the use of the riding sleeves 127″ allows for more flexibility in choosing appropriate materials for the drag brake drum portion 146″ and for the riding sleeves 127″. For instance, the riding sleeves 127″ may be advantageously made from a material with some flexibility (so that they can collapse onto the outer diameter of the drag brake drum portion 146″), and with some self-lubricating property. Furthermore, if riding sleeves 127″ are used, it is possible to simply replace the riding sleeves 127″ in the event of high wear between the coil springs 126″ and the riding sleeves 127″, instead of having to replace the drag brake drum portion 146″. The rest of the description describes only one set of riding sleeve 127″ and coil spring 126″ (unless otherwise noted), with the understanding that two or more sets may also be used with essentially the same operating principle but with possibly advantageous results as discussed above.

The flat spring 124″ is assembled to the motor output spool 122″ in the same manner as has already been described for the motor output spool 122 of FIG. 2. The assembled flat spring 124″ and motor output spool 122″ are then assembled into the motor housing portion 128″ and the brake housing portion 130″ with the opening 166″ of the flat spring 124″ sliding over the hollow shaft projections 158″ and 160″ of the motor housing portion 128″ and the brake housing portion 130″, respectively.

The riding sleeves 127″ and the coil springs 126″ are then assembled onto the drag brake drum portion 146″ as shown in FIG. 15B, wherein the riding sleeves 127″ and the coil springs 126″ are mounted in series onto the outer diameter of the drag brake drum portion 146″. The coil spring 126″ is mounted onto its corresponding riding sleeve 127″ such that the curled end 190″ of the coil spring 126″ projects through the slotted opening 192″ of the riding sleeve 127″. Each riding sleeve 127″ includes circumferential flanges 194″ at each end to assist in keeping the coil spring 126″ from slipping off its corresponding riding sleeve 127″ during operation of the spring motor and drag brake combination 102″.

The assembled drag brake drum portion 146″, coil springs 126″, and riding sleeves 127″ are then mounted onto the extended shaft 148″ of the motor output spool 122″, making sure that the curled end 190″ of each coil spring 126″ is caught in one of the slotted openings 188″ of the brake housing portion 130″. The drag brake drum portion 146″ is rotated until the non-circular profiles 176″, 186″ of the motor output spool 122″ and of the drag brake drum portion 146″ respectively are aligned such that the lift rod 118 can be inserted through the entire assembly as shown in FIG. 13.

During operation, as shown from the vantage point of FIG. 12, as the motor output spool 122″ is rotated counterclockwise (corresponding to the lowering of the shade 100 and the transfer of the flat spring 124″ from the storage spool 162″ to the motor output spool 122″), both the motor output spool 122″ and the drag brake drum portion 146″ rotate in this counterclockwise direction. The riding sleeves 127″ are also urged to rotate in this same direction (due to the friction between the riding sleeves 127″ and the drag brake drum portion 146″), and the coil springs 126″ are also urged to rotate in this same direction (due to the friction between the riding sleeves 127″ and the coil springs 126″). However, the curled ends 190″ of the coil springs 126″ are secured to the brake housing portion 130″ and are prevented from rotation, so, as the rest of the coil springs 126″ begin rotating in the counterclockwise direction, the coil springs 126″ tighten onto the riding sleeves 127″. The riding sleeves 127″ collapse slightly onto the outer diameter of the drag brake drum portion 146″, thus providing an increased resistance to rotation of the drag brake drum portion 146″ (and of the lift rod 118 which is engaging the drag brake drum portion 146″).

When lifting the shade 100, the spring motor and drag brake combination 102″ assists the user as the flat spring 124″ unwinds from the motor output spool 122″ (which is therefore rotating clockwise) and winds onto the storage spool 162″. The drag brake drum portion 146″ also rotates clockwise, which urges the riding sleeves 127″ and the coil springs 126″ to rotate clockwise. Again, since the curled ends 190 of the coil springs 126″ are secured to the slotted openings 188″ of the brake housing portion 130″, the coil springs 126″ “grow” or expand, increasing their inside diameter and greatly reducing the braking torque on the riding sleeves 127″ and on the drum portion 146″. The drag brake drum portion 146″ is therefore able to rotate with little resistance from the coil springs 126″. The user thus can raise the shade 100 easily, assisted by the spring motor and drag brake combination 102″.

FIG. 12A depicts the same embodiment of a spring motor and drag brake combination 102′″ as FIG. 12, except that one of the coil springs 126″ has been flipped over 180 degrees relative to the coil spring 126″, and it is made from a wire material which has a thinner cross section. Now, when the drag brake drum portion 146″ rotates clockwise, the riding sleeves 127″ and the coil springs 126″ also to rotate clockwise. However, in this instance, clockwise rotation causes the second coil spring 126″ to tighten down onto its riding sleeve 127″, reducing the inside diameter of the riding sleeve 127″ and thus clamping down on the drag brake drum portion 146″. Since the cross sectional diameter of this second coil spring 126″ is smaller than the cross sectional diameter of the first coil spring 126″, the drag torque applied to the drag brake drum portion 146″ when it rotates in a clockwise direction is smaller than the drag torque applied to the drag brake drum portion 146″ when the rotation is in a counterclockwise direction. If the cross-sectional dimension of the wire of the second coil spring were greater than the cross-sectional dimension of the wire of the first coil spring 126″, then the braking torque would be greater in the clockwise direction. If the two coil springs 126″ were identical but still reversed from each other, then the braking torque would be the same in both directions.

FIGS. 16 and 17 depict another embodiment of a spring motor and drag brake combination 102*. A comparison with FIG. 12 shows that this embodiment 102* is substantially identical to the previously disclosed embodiment 102″ except that this embodiment does not have the riding sleeves 127″ and it only has a single coil spring 126*. However, two or more such coil springs 126* may be used if desired, as was the case with the previously described embodiment 102″. The coil spring 126* rides directly on the outer diameter of the drag brake drum portion 146* instead of using the riding sleeves 127″. Other than these differences, this spring motor and drag brake combination 102* operates in essentially the same manner as the previously described embodiment 102″.

It should be noted that in this spring motor and drag brake combination 102*, as is the case with all of the spring motor and drag brake combinations described herein, the coil spring 126** or the flat spring 124** may be omitted from the assembly. If the coil spring 126** is omitted, the spring motor and drag brake combination 102* operates as a spring motor only, with no drag brake capability. Likewise, if the flat spring 124** is omitted, the spring motor and drag brake combination 102* operates as a drag brake only, with no motor capability.

FIG. 18 depicts another embodiment of a spring motor and drag brake combination 102**. A comparison with FIG. 5 shows that this embodiment 102** is substantially identical to the embodiment 102 except that, in this spring motor and drag brake combination 102**, the storage spool 162* is not a hollow spool as was the case for the previously described embodiment 102. So, in this case, a lift rod cannot pass through the storage spool 162*. Other than this difference, this spring motor and drag brake combination 102** operates in essentially the same manner as the embodiment 102.

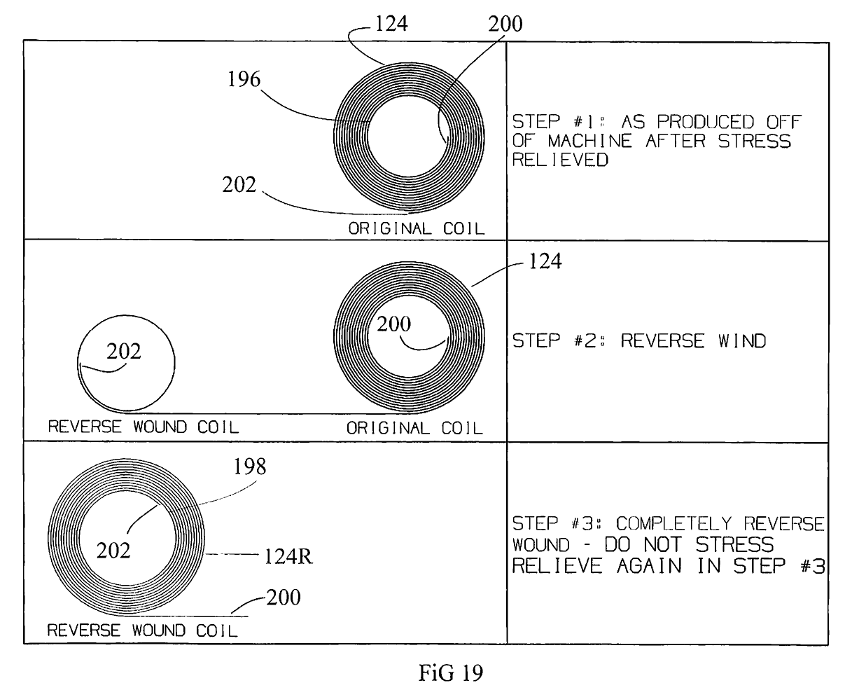

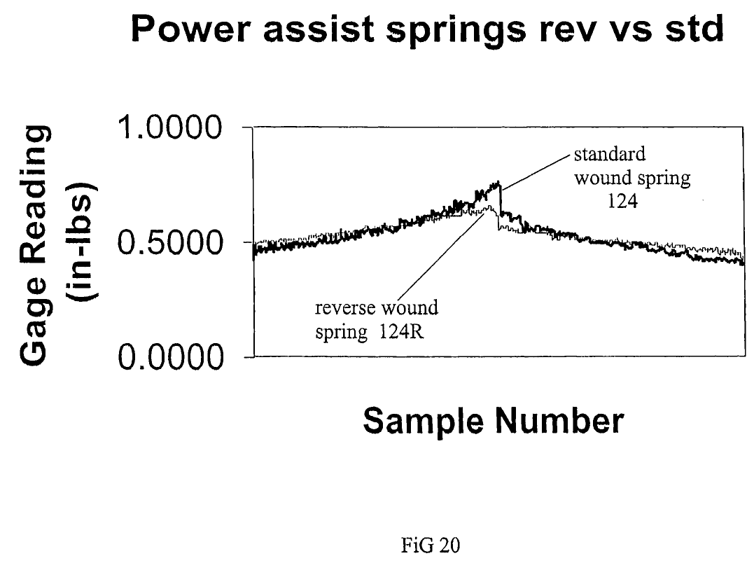

FIGS. 19 and 20 depict an embodiment of a flat spring (or motor spring), which may be used in the embodiments described in this specification, if desired. The flat spring 124, shown in step #1, is made by tightly wrapping a flat metal strip onto itself, after which the coil is stress relieved. This flat spring defines an inside diameter 196, which, in this embodiment, is 0.25 inches. The spring 124 as shown at the end of step #1 may be used in the embodiments described above, or the spring may undergo additional steps, as shown in FIG. 19.

In step # 1, the coil spring 124 is first wound such that the first end 200 of the spring 124 is inside the coil and the second end 202 of the spring 124 is outside the coil. The coil spring 124 is then stress relieved so it takes the coil set shown in FIG. 1, with the spring having a smaller radius of curvature at its first (inner) end and gradually and continuously increasing to its second (outer) end. Next, in step #2, the coil spring 124 is reverse wound until it reaches the position shown in step #3, in which the end 200 of the spring 124 (having the smaller coil set radius of curvature) is now outside the coil and the end 202 of the spring 124 (having the larger coil set radius of curvature) is now inside the coil, with the coil set radius of curvature gradually and continuously decreasing from the inner end to the outer end. This reverse-wound coil 124R is not stress relieved again. Also, this reverse-wound coil 124R defines an inside diameter 198 which preferably is slightly larger than the inside diameter 196 of the original flat spring 124. In this embodiment 124R, the inside diameter is 0.29 inches.

FIG. 20 graphically depicts the power assist torque curve for the standard-wound flat spring 124 (as it stands at the end of step #1) and contrasts it with the torque curve for the reverse-wound flat spring 124R at the end of step #3 of FIG. 19. It depicts the torque forces from the moment the springs begins to unwind (far left of the graph) until they are fully unwound (this is the point, toward the middle of the graph, where the curves show a sharp drop) and then back until the springs are fully rewound (far right of the graph). It can be appreciated that the power assist torque curve for the reverse-wound flat spring 124R is a flatter curve across the entire operating range of the spring than that of the standard-wound flat spring 124. This flatter torque curve is typically a desirable characteristic for use in the type of spring motors used for raising and lowering window coverings.

Referring briefly now to FIG. 2, if one replaces the flat spring 124 with the reverse-wound spring 124R of FIG. 19, the end 200 of the reverse-wound spring 124 (which has the smaller coil set radius of curvature) is the end 142 with the hole 144 that allows it to be attached to the output spool 122. The lever arm acting on the output spool 122 is defined as the distance from the axis of rotation of the output spool 122 to the surface 132 of the output spool 122. This lever arm is at a minimum when the reverse-wound spring 124R is substantially unwound from the output spool 122 and substantially wound onto itself. Therefore, with this arrangement, the portion of the reverse-wound spring 124R which has the highest spring rate (the smallest coil set radius of curvature) is acting on the smallest lever arm.

When the reverse-wound spring 124R is substantially wound onto the output spool 122, the lever arm acting on the output spool 122 will have increased by the thickness of the spring coil which is now wound onto the output spool 122. The lever arm will therefore be at a maximum when the lowest spring rate of the reverse-wound spring 124R (the portion with the largest coil set radius of curvature) is acting on the output spool. The end result is a smoothing out of the power assist torque curve, as shown in FIG. 20.

The procedure depicted in FIG. 19 for reverse winding the spring 124 is but one way to vary the spring rate along the length of the spring while maintaining a uniform thickness and width of the metal strip that forms the spring. Similar results may be obtained using other procedures, and it is possible to design the coil set curvature of the spring 124 to obtain a torque curve with a negative slope, or any other desired slope.

For instance, the metal strip that forms the spring 124 may be drawn across an anvil at varying angles to change the coil set rate of curvature (and therefore the spring rate) for various portions of the spring 124, without changing other physical parameters of the spring. By changing the angle at which the metal is drawn across the anvil, the spring rate may be made to increase continually or decrease continually from one end of the spring to the other, or it may be made to increase from one end to an intermediate point, stay constant for a certain length of the coil, and then decrease, or increase and then decrease, or to vary stepwise or in any other desired pattern, depending upon the application for which it will be used. The coil set radius of curvature of the spring may be manipulated as desired to create the desired spring force at each point along the spring in order to result in the desired power assist torque curve for any particular application.

The coil set radius of curvature in the prior art generally is either constant throughout the length of the flat spring or continuously increases from the inner end 200 to the outer end 202, with the outer end 202 connected to the output spool of the spring motor. However, as explained above, a flat spring may be engineered so that a portion of the flat spring that is farther away from the end that is connected to the output spool may have a coil set with a larger radius of curvature than a portion of the flat spring that is closer to the end that is connected to the output spool, as is the case with the reverse wound spring shown in step #3 of FIG. 19 and as is the case in many of the other engineered flat spring arrangements described above. The coil set radius of curvature may have a third portion still farther away from the end that is connected to the output spool that is smaller than the larger radius portion, or it may remain constant from the larger radius portion to the other end, and so forth.

It will be obvious to those skilled in the art that modifications may be made to the embodiments described above without departing from the scope of the present invention as defined by the claims. For instance, the drag brake mechanism could be attached to a spring motor storage spool that is mounted for rotation relative to the housing, which would still make it functionally attached to the spring motor's output spool and still achieve the same results. Many other modifications could be made as well.

What is claimed is:

1. A spring motor and drag brake combination, comprising:
an output spool mounted for rotation in clockwise and counterclockwise directions;
a motor spring wound upon itself and defining a first end and a second end, said first end secured to said output spool; and
a brake, including
a brake drum functionally connected to said output spool such that rotation of said output spool results in rotation of said brake drum;
a coil spring assembly mounted onto said brake drum; and
a housing;
wherein said coil spring assembly is mounted by mounting means which cause said coil spring assembly to resist rotation of said brake drum relative to said housing in both the clockwise and counterclockwise directions, with the torque required to overcome the resistance to rotation being greater in one of said directions than in the other.

2. A spring motor and drag brake combination as recited in claim 1, wherein said housing defines an inner bore and said coil spring assembly includes a smaller diameter spring portion and a larger diameter spring portion;
wherein said smaller diameter spring portion collapses onto said brake drum and said larger diameter spring portion contracts away from said inner bore when said brake drum rotates in one of said clockwise and counterclockwise directions relative to said housing; and
wherein said smaller diameter spring portion expands away from said brake drum and said larger diameter spring portion expands against said inner bore when said brake drum rotates in the other of said clockwise and counterclockwise directions relative to said housing.

3. A spring motor and drag brake combination as recited in claim 2, wherein said coil spring assembly comprises a first coil spring providing said smaller diameter spring portion; a second coil spring providing said larger diameter spring portion, and a spring coupler functionally connecting said first and second coil springs such that both of said coil springs rotate together as a single assembly.

4. A spring motor and drag brake combination as recited in claim 2, wherein the coil spring assembly exerts torques against both the brake drum and the inner bore of the housing which resist rotation of the brake drum relative to the housing in both the clockwise and counterclockwise directions; and wherein the coil spring assembly slips relative to the brake drum in order to allow the brake drum to rotate relative to the housing in one of the clockwise and counterclockwise directions, and the coil spring assembly slips relative to the bore of the housing in order to allow the brake drum to rotate relative to the housing in the other of said directions.

5. A spring motor and drag brake combination as recited in claim 4, wherein, as said smaller diameter spring portion is expanding away from said brake drum, said motor spring is winding onto said output spool.

6. A spring motor and drag brake combination as recited in claim 5, wherein said smaller diameter spring portion is made of wire having a first cross-sectional dimension, and said larger diameter spring portion is made of wire having a second cross-sectional dimension which is different from said first cross-sectional dimension.

7. A spring motor and drag brake combination as recited in claim 1, and further comprising a covering for an architectural opening which is functionally connected to said brake drum so that said brake drum rotates in one of said clockwise and counterclockwise directions as said covering is being extended and operates in the other of said clockwise and counterclockwise directions as said covering is being retracted.

8. A spring motor and drag brake combination as recited in claim 2, wherein said housing defines two pairs of axially-aligned openings and two parallel open pathways, each open pathway extending completely through said housing and through one of the respective pairs of axially-aligned openings and being suitable for receiving a shaft extending through the housing, one of said open pathways extending axially through said output spool.

9. A spring motor and drag brake combination as recited in claim 2, wherein said smaller diameter spring portion and said larger diameter spring portion are portions of a single spring.

10. A spring motor and drag brake combination as recited in claim 1, wherein said coil spring assembly includes a first coil spring mounted onto said brake drum, said first coil spring including a first end secured to said housing, wherein said first coil spring collapses onto said brake drum when said output spool rotates in one of said clockwise and counterclockwise directions.

11. A spring motor and drag brake combination as recited in claim 10, wherein said coil spring assembly further comprises a second coil spring mounted onto said brake drum, said second coil spring including a first end secured to said housing, wherein said second coil spring collapses onto said brake drum when said output spool rotates in the other of said clockwise and counterclockwise directions.

12. A spring motor and drag brake combination as recited in claim 10, wherein said coil spring assembly includes a collapsible sleeve intermediate said brake drum and said first coil spring.

13. A spring motor and drag brake combination as recited in claim 10, wherein said housing defines two pairs of axially-aligned openings and two parallel open pathways, each open pathway extending completely through said housing and through one of the respective pairs of axially-aligned openings and being suitable for receiving a shaft extending through the housing, one of said open pathways extending axially through said output spool.

14. A covering system for covering an architectural opening, comprising:
a movable covering; and
a spring motor operatively connected to said movable covering, said spring motor including an output spool and a flat spring having a first end connected to said output spool, in which at least one portion of the flat spring which is farther away from said first end has a coil set with a larger radius of curvature than a second portion of the flat spring which is closer to said first end and has a coil set with a smaller radius of curvature.

15. A covering system for covering an architectural opening as recited in claim 14, wherein the radius of curvature of said flat spring increases continuously from a smaller radius of curvature at the first end to a larger radius of curvature at the second end.

16. A covering system for covering an architectural opening as recited in claim 14, wherein there is a third portion of said flat spring farther away from said first end than said one portion which has a coil set with a smaller radius of curvature than said one portion.

17. A covering system for covering an architectural opening as recited in claim 14, wherein the output spool is mounted for rotation in clockwise and counterclockwise directions, and further comprising:
a brake drum functionally connected to said output spool such that rotation of said output spool results in rotation of said brake drum;
a housing; and
a coil spring assembly mounted onto said brake drum by mounting means which cause said coil spring assembly to resist rotation of said brake drum relative to said housing in both the clockwise and counterclockwise directions, with the torque required to overcome the resistance to rotation being greater in one of said directions than in the other.

18. A covering system for covering an architectural opening as recited in claim 17, wherein said housing defines an inner bore; wherein said coil spring assembly includes a smaller diameter spring portion and a larger diameter spring portion, wherein said smaller diameter spring portion collapses onto said brake drum and said larger diameter spring portion contracts away from said inner bore when said brake drum rotates in one of said clockwise and counterclockwise directions, and wherein said smaller diameter spring portion expands away from said brake drum and said larger diameter spring portion expands against said inner bore when said brake drum rotates in the other of said clockwise and counterclockwise directions.

19. A covering system for covering an architectural opening as recited in claim 14, wherein the output spool is mounted for rotation in clockwise and counterclockwise directions, and further comprising:
a brake drum functionally connected to said output spool such that rotation of said output spool results in rotation of said brake drum;
a housing: and
a first coil spring mounted onto said brake drum, said first coil spring including a first end secured to said housing, wherein said first coil spring collapses onto said brake drum when said output spool rotates in one of said clockwise and counterclockwise directions.

20. A covering system for covering an architectural opening, comprising:
a movable covering;
a first shaft operatively connected to said covering;
a second shaft operatively connected to said covering;
a housing; and
a spring within said housing;
wherein said first and second shafts extend completely through said housing, said first shaft operatively engaging said spring, and said second shaft not operatively engaging said spring.

21. A covering system for covering an architectural opening as recited in claim 20, wherein said spring is a flat spring; and further comprising an output spool connected to one end of said flat spring, wherein said first shaft operatively engages said spring by engaging said output spool.

22. A covering system for covering an architectural opening as recited in claim 20, wherein said spring is a coil spring; and further comprising a brake drum that engages the coil spring, wherein said first shaft operatively engages said spring by engaging said brake drum.

23. A covering system for covering an architectural opening as recited in claim 20, wherein said first and second shafts are parallel to each other.

24. A covering system for covering an architectural opening as recited in claim 23, wherein said covering has a width dimension and a height dimension, and wherein said shafts substantially span one of said width and height dimensions.
